(19) United States
(12) Patent Application Publication
(10) Pub. No.: US 2019/0306931 A1
(43) Pub. Date: Oct. 3, 2019

(54) INDUCTION COOKING HOB WITH COOLING SYSTEM

(71) Applicant: ELECTROLUX APPLIANCES AKTIEBOLAG, Stockholm (SE)

(72) Inventors: Simon MALKOMES, Rothenberg ob der Tauber (DE); Alwin NEUKAMM, Rothenberg ob der Tauber (DE); Björn LEYH, Rothenberg ob der Tauber (DE); Gerhard KLEIN, Rothenberg ob der Tauber (DE)

(21) Appl. No.: 16/461,939

(22) PCT Filed: Nov. 30, 2017
(86) PCT No.: PCT/EP2017/080902

§ 371 Date: May 17, 2019

(30) Foreign Application Priority Data
Dec. 12, 2016 (EP) 16203564.6

(51) Int. Cl. H05B 6/12; F24C 15/10; A47J 36/24; A47J 27/00

(52) U.S. Cl. CPC H05B 6/1263; F24C 15/101; H05B 2206/022; A47J 27/002; A47J 27/004; A47J 36/2483

(57) ABSTRACT

The present invention relates to an induction cooking hob with a cooling system. The induction cooking hob comprises a casing (10) and at least one induction module (20) arranged inside said casing (10). The casing (10) includes a bottom plate (12), a front wall (14), a rear wall (16) and two lateral walls (18). The induction module (20) is spaced from the front wall (14), so that a front channel is formed between the induction module (20) and the front wall (14). An air stream (34) from a cooling element (24) is guided through the front channel to at least one lateral outlet hole (30) of the closest lateral wall (18).

The present invention relates to an induction cooking hob with a cooling system. The induction cooking hob comprises one or more induction modules. In particular the induction module includes a circuitry, a cooling element and a cooling fan.

In a conventional induction cooking hob the outlet holes for an air stream are arranged at the front side of said induction cooking hob. Said air stream is provided for cooling purposes, in particular for cooling the circuitry. The air stream exiting the induction cooking hob through the outlet holes has a relative high temperature and reaches an area in front of said induction cooking hob. Usually, the user stands in front of the induction cooking hob and is exposed to the hot air stream. A protection shield is often attached in front of the induction cooking hob in order to avoid the hot air stream reaches the user.

It is an object of the present invention to provide an induction cooking hob, which avoids that the air stream provided for cooling purposes reaches the user.

The object is achieved by the induction cooking hob according to claim 1.

According to the present invention an induction cooking hob with a cooling system is provided, wherein:
the induction cooking hob comprises a casing and at least one induction module arranged inside said casing,
the casing includes a bottom plate, a front wall, a rear wall and two lateral walls,
the induction module is spaced from the front wall, so that a front channel is formed between the induction module and the front wall, and
an air stream from a cooling element is guided through the front channel to at least one lateral outlet hole of the closest lateral wall.

The present invention allows that the air stream leaves the induction cooking hob through the lateral outlet holes and avoids that the hot air stream reaches the user standing in front of said induction cooking hob. A protection shield at the induction cooking hob is not required.

According to a preferred embodiment of the present invention,
the at least one lateral outlet hole is arranged in a front portion of the lateral wall, and
the induction module includes a circuitry, the cooling element and at least one cooling fan.

In particular, the induction cooking hob includes at least one flank arranged beside, beneath and/or above the cooling element, so that the air stream is guided through and/or passes by said cooling element, wherein preferably the flank is fastened at the casing by a snap-in mechanism.

Further, the circuitry and the cooling element may be arranged side-by-side in a front portion of the induction module, wherein at least some components of the circuitry are arranged on the cooling element, and wherein preferably at least one rectifier and/or at least one power unit are arranged on said cooling element.

According to embodiments, the induction cooking hob can comprise one cooling element, at least one cooling element, two cooling elements or at least two cooling elements. The or each cooling element can be formed as a single-piece or by multiple pieces. A cooling element which is formed as a single-piece can provide a good cooling performance. On the other hand, a cooling element which is made from multiple pieces can be advantageous, as it can increase the flexibility for inserting the cooling element with respect to the degrees of freedom of the arrangement as well as the flexibility regarding the space requirement. In an embodiment, the induction cooking hob comprises two or more induction modules, whereas the cooling system comprises two or more cooling elements which are arranged within or adjacent to the two or more induction modules.

Moreover, the cooling fan may be arranged in a rear portion of the induction module and behind the cooling element.

In particular, the cooling element includes a structure that an air stream generated by the cooling fan penetrates or passes said cooling element and reaches the front channel.

Preferably, at least one of the lateral walls includes a plurality of lateral outlet holes arranged in the front portion of said lateral wall.

According to a preferred embodiment the casing includes at least one air guide arranged inside the front channel, so that the air stream from the cooling element is deflected and guided to at least one lateral outlet hole of a closest lateral wall.

Further, the air guide may be formed as a vertical sheet element, wherein preferably said air guide is made of metal and/or plastics.

For example, the air guide is formed as a plane sheet element arranged diagonally inside the front channel and in front of the cooling element.

Moreover, the bottom plate may include at least one lower outlet hole arranged in an outer portion of the front channel, wherein said outer portion is beside the corresponding lateral wall, and wherein preferably a plurality of lower outlet holes is arranged in said outer portion of the front channel.

Additionally, the induction module may be spaced from the closest lateral wall, so that a lateral channel is formed between the induction module and the closest lateral wall. Since the induction module is spaced from the lateral outlet hole, it is not possible that the user touches the circuitry through said lateral outlet holes.

In particular, the bottom plate includes at least one lower outlet hole arranged in a front portion of the lateral channel, wherein preferably a plurality of lower outlet holes is arranged in said front portion of the lateral channel.

Further, the cooling element may include a plurality of cooling fins arranged plane-parallel to each other, wherein a plurality of elongated cooling channels is arranged between said cooling fins, and wherein said elongated cooling channels extend parallel to a connecting line between the cooling fan and the air guide, and wherein preferably the cooling fins extend vertically downwards, so that the elongated cooling channels are formed between the cooling fins and the bottom plate of the casing.

For example, the cooling fan is a radial cooling fan and blows the air stream from the rear to the front, wherein preferably the cooling fan sucks the air at the rear side of the induction cooking hob.

According to the preferred embodiment of the present invention, the induction cooking hob comprises two induction modules arranged side-by-side, wherein a first air guide is arranged in front of the cooling element of the induction module on a first side, while a second air guide is arranged in front of the cooling element of the induction module on a second side, and wherein the first air guide deflects the air stream to the at least one lateral outlet hole of the lateral wall on the first side, while the second air guide deflects the air stream to the at least one lateral outlet hole of the lateral wall on the second side.

In this case, the induction module on the first side may be spaced from the lateral wall on the first side, while the induction module on the second side may be spaced from the lateral wall on the second side, so that a first and a second lateral channel are formed between the corresponding induction modules and lateral walls.

Additionally, at least one central induction module may be arranged between two lateral induction modules. In this case, the induction cooking hob comprises three or more induction modules arranged side-by-side.

Furthermore, the induction cooking hob comprises a panel, in particular a glass ceramic panel, covering an open top side of the casing.

Moreover, the induction cooking hob comprises at least one induction coil, in particular a plurality of induction coils, electrically connected to the corresponding circuitry.

At last, the at least one induction coil may be arranged between the at least one induction module and the panel.

Novel and inventive features of the present invention are set forth in the appended claims.

The present invention will be described in further detail with reference to the drawing, in which

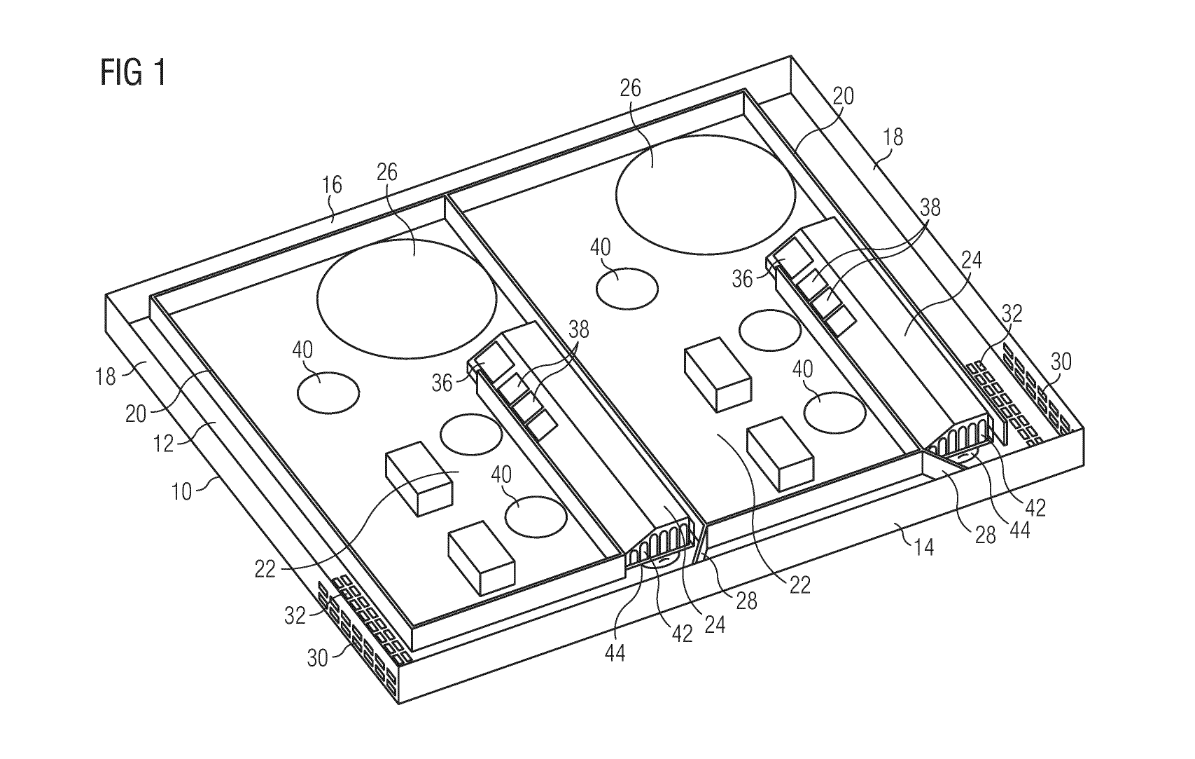

FIG. 1 illustrates a schematic perspective view of an induction cooking hob according to a preferred embodiment of the present invention, and

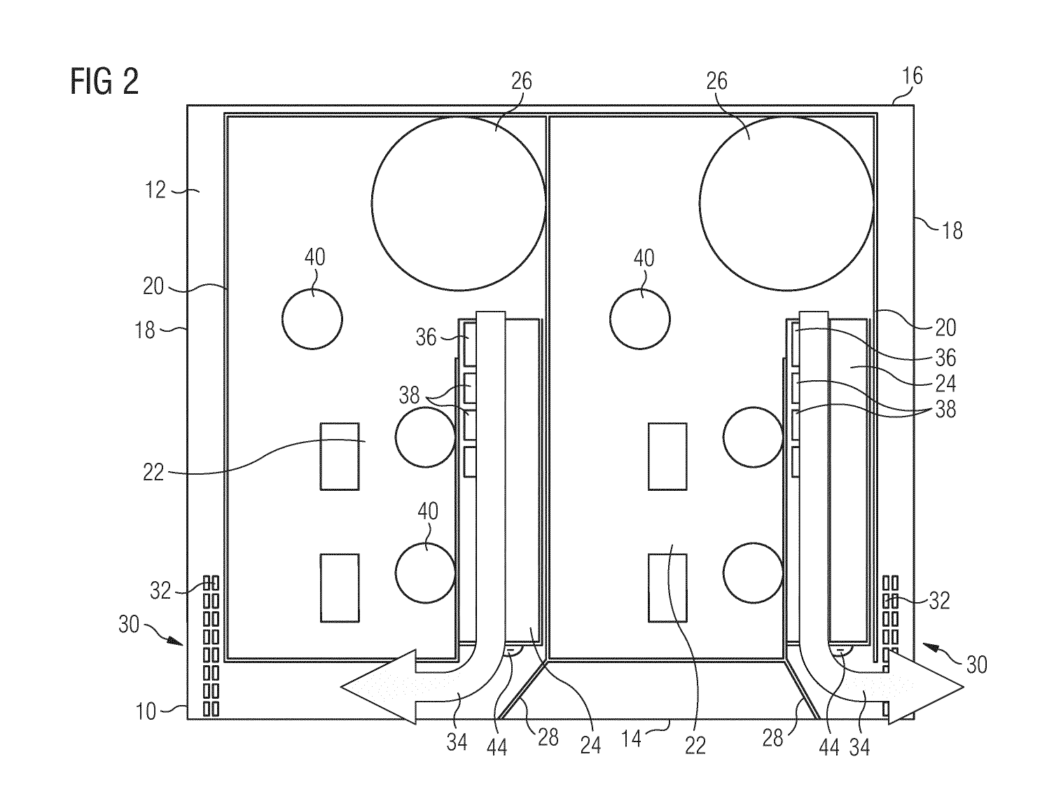

FIG. 2 illustrates a schematic top view of the induction cooking hob according to the preferred embodiment of the present invention.

FIG. 1 illustrates a schematic perspective view of an induction cooking hob according to a preferred embodiment of the present invention.

The induction cooking hob comprises a casing 10. Said casing 10 includes a bottom plate 12, a front wall 14, a rear wall 16 and two lateral walls 18. The terms “bottom”, “front”, “rear”, “lateral” further prepositions relate to the built-in state of the induction cooking hob. The casing 10 includes an open top side covered by a panel, in particular by a glass ceramic panel. Said panel is not shown in FIG. 1.

Further, the induction cooking hob comprises two induction modules 20. Said induction modules 20 are arranged side-by-side within the casing 10. The induction modules 20 are arranged close to the rear wall 16, but spaced from the front wall 14 and the corresponding lateral wall 18. Thus, a front channel is formed between the induction modules 20 and the front wall 14, while two lateral channels are formed between the induction modules 20 and the corresponding lateral wall 18.

Each induction module 20 includes a circuitry 22, one or at least one cooling element 24 and a cooling fan 26. Each cooling element 24 can be made from one piece or from several pieces.

In the embodiment, the induction cooking hob comprises two or at least two cooling elements 24. If one or each cooling element 24 is made from a single piece, the cooling performance is increased, as the heat conductance is improved. On the other hand, if a or each cooling element 24 is made from several or multiple pieces, the flexibility of arranging the cooling element is increased and the arrangement within the available space can be optimised.

The circuitry 22 and the cooling element 24 are arranged side-by-side in a front portion of the induction module 20, while the cooling fan 26 is arranged behind the cooling element 24. On the output side the circuitry 22 is electrically connected to one or more induction coils. The induction coils are arranged above the induction modules 20 and beneath the panel. The induction coils are not shown in FIG. 1. The circuitry 22 is mechanically and thermally coupled to the cooling element 24, so that heat is conducted from the circuitry 22 to the cooling element 24. The cooling element 24 includes a plurality of cooling fins 42 arranged plane-parallel to each other. A plurality of cooling channels is arranged between the cooling fins 42. In this example, the cooling fins 42 extend vertically downwards, i.e. the open ends of said cooling fins 42 form the bottom of the cooling element 24. The cooling elements 24 are elongated and extend from the cooling fan 26 to the front channel.

Further, a flank 44 is arranged beneath and beside the cooling element 24. In this example, the flank 44 is formed as a U-shaped profile part and encloses partially the cooling element 24. The flank 44 contributes that the air stream 34 is guided through and passes by, respectively, the cooling element 24. For example, the flank 44 is fastened at the casing 10 by a snap-in mechanism. In general, at least one flank 44 may be arranged beside, beneath and/or above the cooling element 24, so that the air stream 34 is guided through and/or passes by said cooling element 24.

The circuitry 22 comprises a rectifier 36, one or more power units, filter coils 40 and further electric and/or electronic components. In this example, each power unit is formed by a pair of insulated-gate bipolar transistors (IGBT) 38. Alternatively, other power units may be used instead of the IGBT 38.

As shown in FIG. 1, the rectifier 36 and four pairs of the insufated-gate bipolar transistors 38 are directly connected to the cooling element 24. However, a separation layer is usually arranged between the rectifier 36 and the insulated-gate bipolar transistors 38, respectively, on the one hand and the cooling element 24 on the other hand in order to prevent a direct contact between the components. In this example, the rectifier 36 and the four pairs of the insulated-gate bipolar transistors 38 are connected to the cooling element 24 by screws. The rectifier 36 and the insulated-gate bipolar transistors 38 require cooling. The rectifier 36 is provided for converting an input alternating current voltage into a pulsed direct current voltage. The pair of insulated-gate bipolar transistors 38 acts as inverted rectifier and converts said pulsed direct current voltage into an alternating voltage for a corresponding induction coil. Usually, the input alternating current voltage has a frequency between 50 Hz and 60 Hz. In contrast, the frequency of the alternating voltage for the induction coils is between about 10 kHz and 100 kHz.

The rectifier 36 is usually formed as a bridge rectifier circuit and formed by diodes. The rectifier 36 and the insulated-gate bipolar transistors 38 are so-called power switches. The total electric power is delivered to the rectifier 36 and insulated-gate bipolar transistors 38. The total electric power of each induction module 20 passes the rectifier 38. Each pair of insulated-gate bipolar transistors 38 is provided with a part of said total electric power. For example, up to about 50% of the total electric power is delivered to one pair of insulated-gate bipolar transistors 38. Thus, the rectifier 36 and the insulated-gate bipolar transistors 38 generate a lot of heat.

In this example, the cooling element 24 is elongated, wherein the rectifier 36 and the insulated-gate bipolar transistors 38 are arranged in series along a longitudinal axis of said cooling element 24. The rectifier 36 and the insulated-gate bipolar transistors 38 are attached on a sloped cooling surface of the cooling element 24, wherein said sloped cooling surface forms a transition between a top surface and a lateral surface of the cooling element 24. The cooling fins 42 extend along the longitudinal axis of the cooling element 24. An air stream 34 generated by the cooling fan 26 passes the cooling element 24 along its longitudinal axis. The air stream 34 passes successively the rectifier 36 and each of the insulated-gate bipolar transistors 38. The rectifier 36 or one insulated-gate bipolar transistor 38 may also use the sloped cooling surface beneath the neighboured insulated-gate bipolar transistors 38, which is advantageous, since the insulated-gate bipolar transistors 38 are usually stressed by different powers.

In this example, the cooling element 24 is formed as a single-piece part. Alternatively, the cooling element 24 may be multi-part. The cooling element 24 formed as single-piece part allows an efficient heat transfer. The cooling fins 42 provide an extended surface within the cooling element 24, which contributes to the efficient heat transfer. Further, the cooling element 24 is relatively flat. The elongated and flat cooling element 24 requires only little space within the casing 10 of the induction cooking hob.

The flank 44 is arranged beneath and beside the cooling element 24 and encloses partially the lower portion of the cooling element 24. The flank 44 allows that the air stream 34 is guided through and passes by, respectively, said cooling element 24.

Moreover, the casing 10 includes two air guides 28. The air guides 28 are formed as vertical sheet elements and arranged in the front channel. The air guides 28 are made of metal or plastics. Each air guide 28 corresponds with one of the induction modules 20. The air guides 28 are arranged diagonally respective to the cooling fins 42 of the cooling element 24 and to the front channel. Each air guide 28 is arranged in front of the corresponding cooling element 24.

Furthermore, each lateral wall 18 of the casing 10 includes a plurality of lateral outlet holes 30. Said lateral outlet holes 30 are arranged in the front portions of the lateral walls 18. A plurality of lower outlet holes 32 is formed in the bottom plate 12 of the casing 10. Said lower outlet holes 32 are arranged in the front portions of the lateral channel between the induction module 20 and the adjacent lateral wall 18. The lower outlet holes 32 are arranged beneath and beside the lateral outlet holes 30.

FIG. 2 illustrates a schematic top view of the induction cooking hob according to the preferred embodiment of the present invention.

The induction cooking hob comprises the casing 10 including the bottom plate 12, the front wall 14, the rear wall 16 and the both lateral walls 18. The open top side of the casing 10 is covered by the panel, which is not shown in FIG. 2. The both induction modules 20 are arranged side-by-side within the casing 10. The induction modules 20 are arranged close to the rear wall 16 of the casing 10. The induction modules 20 are spaced from the front wall 14 and the corresponding lateral wall 18 of the casing 10. The front channel is formed between the induction modules 20 and the front wall 14 of the casing 10. The both lateral channels are formed between the induction modules 20 and the corresponding lateral wall 18 of the casing 10.

The induction modules 20 include the circuitry 22, the cooling element 24 and the cooling fan 26 in each case. The circuitry 22 and the cooling element 24 are arranged side-by-side in the front portion of the induction module 20. The cooling fan 26 is arranged behind the cooling element 24. On the output side the circuitry 22 is electrically connected to the at least one induction coil. The induction coils are arranged above the induction modules 20 and beneath the panel. The induction coils are not shown in FIG. 2. The circuitry 22 and the cooling element 24 are mechanically and thermally coupled to each other. Thus, heat is conducted from the circuitry 22 to the cooling element 24. The cooling element 24 is elongated and extends from the cooling fan 26 to the front channel.

The air guides 28 are formed as vertical sheet elements and arranged in the front channel between the induction modules 20 and the front walls 14. One of the air guides 28 corresponds with one of the induction modules 20. The air guides 28 are arranged diagonally relative to the cooling fins 42 of the cooling element 24 and to the front channel. The air guide 28 is arranged in front of the corresponding cooling element 24.

The lateral outlet holes 30 are arranged in the front portions of the lateral walls 18. The lower outlet holes 32 are formed in the bottom plate 12 of the casing 10, wherein said lower outlet holes 32 are arranged in the front portions of the lateral channel between the induction module 20 and the adjacent lateral wall 18. Further, the lower outlet holes 32 are arranged beneath and beside the lateral outlet holes 30.

The cooling fan 26 is a radial cooling fan and generates the air stream 34. The cooling fan 26 sucks air in a rear portion of the casing 10 and blows the air stream 34 horizontally from the rear to the front. Said air stream 34 enters the cooling channels formed between the cooling fins 42 of the cooling element 24. Within the cooling element 24 the air stream 34 flows from the rear to the front. After the air stream 34 has left the cooling element 24, the air guide 28 deflects the air stream 34. Then, the air stream 34 flows along the front channel and against the lateral wall 18 of the casing 10. On the left hand side of FIG. 2, the air stream 34 flows from right to left within the corresponding front channel. In a similar way, the air stream 34 flows from left to right within the corresponding front channel on the right hand side of FIG. 2. At last, the air stream 34 leaves the casing 10 through the lateral outlet holes 30 and lower outlet holes 32.

The cooling fan 26 is an active component, while the cooling element 24 is a passive component. The combination of the active cooling fan 26 and the passive cooling element 24 provides an efficient cooling effect, since the cooling fan 26 delivers a big amount of cooling air through the cooling element 24. The cooling air removes permanently heat from the rectifier 36 and the insulated-gate bipolar transistors 38.

In this example, the induction cooking hob comprises two induction modules 20. In general, the induction cooking hob according to the present invention comprises two or more induction modules 20. According to a further example, the induction cooking hob may comprise three or more induction modules 20 arranged side-by-side. The induction modules 20 allow the preparation of different induction cooking hobs.

The induction cooking hob according to the present invention avoids that the air stream provided for cooling purposes reaches the user. A protection shield at the induction cooking hob is not required. Since the induction modules 20 are spaced from the lateral outlet holes 30, it is not possible that the user touches the circuitry 22 through said lateral outlet holes 30.

Although an illustrative embodiment of the present invention has been described herein with reference to the accompanying drawings, it is to be understood that the present invention is not limited to that precise embodiment, and that various other changes and modifications may be affected therein by one skilled in the art without departing from the scope or spirit of the invention. All such changes and modifications are intended to be included within the scope of the invention as defined by the appended claims.

### LIST OF REFERENCE NUMERALS

10 casing

12 bottom plate

14 front wall

16 rear wall

18 lateral wall

20 induction module

22 circuitry

24 cooling element

26 cooling fan

28 air guide

30 outlet holes

32 outlet holes

34 air stream

36 rectifier

38 isolated-gate bipolar transistor (IGBT)

40 filter coil

42 cooling fins

44 flank

1. An induction cooking hob with a cooling system, comprising: a casing and at least one induction module arranged inside said casing,
the casing including a bottom plate, a front wall, a rear wall and two lateral walls,
the induction module being spaced from the front wall, so that a front channel is formed between the induction module and the front wall,
wherein an air stream from a cooling element is guided through the front channel to at least one lateral outlet hole of the closest lateral wall.

2. The induction cooking hob according to claim 1, wherein
the at least one lateral outlet hole is arranged in a front portion of the lateral wall, and
the induction module includes a circuitry, the cooling element and at least one cooling fan.

3. The induction cooking hob according to claim 1, further comprising at least one flank arranged beside, beneath and/or above the cooling element, so that the air stream is guided through and/or passes by said cooling element.

4. The induction cooking hob according to claim 2, wherein the circuitry and the cooling element are arranged side-by-side in a front portion of the induction module, wherein at least some components of the circuitry are arranged on the cooling element.

5. The induction cooking hob according to claim 2, wherein the the at least one cooling fan is arranged in a rear portion of the induction module and behind the cooling element.

6. The induction cooking hob according to claim 2, wherein the cooling element includes a structure that said air stream generated by the cooling fan penetrates or passes said cooling element and reaches the front channel.

7. The induction cooking hob according to claim 1, wherein at least one of the lateral walls includes a plurality of said lateral outlet holes arranged in the front portion of said lateral wall.

8. The induction cooking hob according to claim 1, wherein the casing includes at least one air guide arranged inside the front channel, so that the air stream from the cooling element is deflected and guided to said at least one lateral outlet hole.

9. The induction cooking hob according to claim 1, wherein the air guide is formed as a vertical sheet element, wherein said air guide is made of metal and/or plastics.

10. The induction cooking hob according to claim 1, wherein the bottom plate includes at least one lower outlet hole arranged in an outer portion of the front channel, wherein said outer portion is beside the corresponding lateral wall.

11. The induction cooking hob according to claim 1, wherein the induction module is spaced from the closest lateral wall so that a lateral channel is formed between the induction module and said closest lateral wall, wherein the bottom plate includes at least one lower outlet hole arranged in a front portion of the lateral channel.

12. The induction cooking hob according to claim 1, wherein the cooling element includes a plurality of cooling fins arranged plane-parallel to each other, wherein a plurality of elongated cooling channels are arranged between said cooling fins, and wherein said elongated cooling channels extend parallel to a connecting line between the cooling fan and the air guide.

13. The induction cooking hob according to claim 2, wherein the at least one cooling fan is a radial cooling fan and blows the air stream from a rear to a front.

14. The induction cooking hob according to claim 2, comprising two said induction modules arranged side-by-side, wherein a first air guide is arranged in front of the cooling element of a first said induction module on a first side, while a second air guide is arranged in front of the cooling element of a second said induction module on a second side, and wherein the first air guide deflects the air stream to a said lateral outlet hole of the lateral wall on the first side, while the right air guide deflects the air stream to a said lateral outlet hole of the lateral wall on the second side, and/or wherein the first induction module on the first side is spaced from the lateral wall on the first side, while the second induction module on the second side is spaced from the lateral wall on the second side, so that first and a second lateral channels formed between the corresponding induction modules and lateral walls.

15. The induction cooking hob according to claim 1, further comprising a panel covering an open top side of the casing, and at least one induction coil, connected to the circuitry, and wherein the at least one induction coil is arranged between the at least one induction module and the panel.

16. The induction cooking hob according to claim 4, wherein at least one rectifier and/or at least one power unit are arranged on said cooling element.

17. The induction cooking hob according to claim 9, wherein said air guide is formed as a plane sheet element arranged diagonally inside the front channel and in front of the cooling element.

18. The induction cooking hob according to claim 12, wherein the cooling fins extend vertically downwards, so that the elongated cooling channels are formed between the cooling fins and the bottom plate of the casing.

19. An induction cooking hob comprising: a casing having a front wall and opposing lateral side walls; a first induction module located within, and adjacent a first of said lateral side walls of, said casing; said first induction module being spaced from said front wall thus defining a front channel between said first induction module and said front wall, and being spaced from said first lateral side wall thus defining a first lateral channel between said first induction module and said first lateral side wall; said first induction module comprising a first fan, first circuitry for operating a first induction coil and a first cooling element extending from adjacent said first fan toward said front channel, said first cooling element being thermally coupled to said first circuitry so that heat will be conducted from said first circuitry to said first cooling element, said first cooling element having a plurality of vertically extending and elongated first cooling fins with respective first cooling channels arranged between adjacent pairs of said first cooling fins; a first air guide arranged in said front channel and adapted to redirect a first flow of cooling air emanating from said first fan, through said first cooling channels and into said front channel, laterally toward said first lateral side wall; and a plurality of first outlet holes in said first lateral channel to provide communication between said first lateral channel and an external environment.

20. The induction cooking hob according to claim 19, further comprising a second induction module located within, and adjacent a second of said lateral side walls of, said casing and being arranged in side-by-side relationship with said first induction module;
said second induction module being spaced from said front wall thus further defining said front channel between said second induction module and said front wall, and being spaced from said second lateral side wall thus defining a second lateral channel between said second induction module and said second lateral side wall; said second induction module comprising a second fan, second circuitry for operating a second induction coil and a second cooling element extending from adjacent said second fan toward said front channel, said second cooling element being thermally coupled to said second circuitry so that heat will be conducted from said second circuitry to said second cooling element, said cooling element having a plurality of vertically extending and elongated second cooling fins with respective second cooling channels arranged between adjacent pairs of said second cooling fins; a second air guide arranged in said front channel and adapted to redirect a second flow of cooling air emanating from said second fan, through said second cooling channels and into said front channel laterally toward said second lateral side wall;
and a plurality of second outlet holes in said second lateral channel to provide communication between said second lateral channel and an external environment.

21. The induction cooking hob according to claim 20, each of said first and second air guides being arranged in front of the associated first or second cooling element, each said first and second air guide being formed as a vertical sheet that is arrange diagonally with respect to the respective first or second cooling fins of the associated first or second cooling element, and with respect to the front channel, at least some of said plurality of first outlet holes being disposed in said first lateral side wall, and at least some of said plurality of second outlet holes being disposed in said second lateral side wall.
